(19) United States
(12) Patent Application Publication
(10) Pub. No.: US 2007/0041875 A1
(43) Pub. Date: Feb. 22, 2007

(54) Flow analysis dispensing needles and nozzles

(76) Inventors: David T. Bach, Ellicott City, MD (US); Ronald R. Genova, Reading, PA (US)

Correspondence Address: Ober, Kaler, Grimes & Shriver;Attorney's at Law, 120 Eat Baltimore Street, Baltimore, MD, 21202-1643, US

(21) Appl. No.: 11/507,067

(22) Filed: Aug. 18, 2006

Related U.S. Application Data
(60) Provisional application No. 60/709,283, filed on Aug. 19, 2005.

(51) Int. Cl. B01L 3/02

(52) U.S. Cl. 422/100

(57) ABSTRACT

An improved needle and nozzle design that allows for precision dispensing and mixing of fluids by assist of an integral optical system coupled to a closed loop controller drive system for real-time monitoring of the small volume precision dispensing requirements of bioscience applications. The needles/nozzles have an optically-transmissive wall or window coupled to an optical system including an optical detector and light source, at least the detector being connected to a closed loop controller drive system (e.g., a “needle/nozzle integrated optical analysis system”). Optical detection can be based on fluorescence, scattered light, absorbance, or a combination, and any optical change in the analysis region can be observed via the transmitted/reflected light and used as feedback to control the pump drive system. Alternate embodiments are shown in which optical fibers or rods are used for coupling the detector to the needle/nozzle, and a lens is used for coupling the fiber(s)/rods into the needle/nozzle.

### CROSS-REFERENCE TO RELATED APPLICATIONS

The present application derives priority from U.S. Provisional Patent Application No. 60/709,283 filed Aug. 19, 2005, and is a continuation-in-part of U.S. patent application Ser. No. (to be assigned) for “DIGITAL INCREMENTAL FLOW ANALYSIS SYSTEM”; filed Jul. 18, 2006.

### BACKGROUND OF THE INVENTION

1. Field of the Invention

The present invention relates to flow analysis in dispensing needles and nozzles and, in more particularly, to an optical analysis system incorporated directly in the needle/nozzle of a precision fluid dispensing system (the very last fluid contact component) for flow analysis therein.

2. Description of the Background

Liquid dispensing systems that use needles and nozzles are often subject to extremely high-precision requirements. This is especially true in bioscience and pharmacological applications where overfills can cause some drugs to become toxic, while underfills can compromise some drugs' effectiveness. It is therefore necessary for manufacturers of filling equipment to provide the best accuracy possible.

Currently, the main ways to ensure liquid fill accuracy are: volumetric filling, time/pressure dosing, and net weight filling.

Existing volumetric pumps can dose ±0.25% absolute of nominal fill weight and may provide the most accuracy attainable. For example, Bausch & Stroebel Machine Company, Inc. (Clinton, Conn.) manufactures such volumetric pumps.

In time/pressure dosing systems the fluid is driven by pressure from nitrogen or sterile air. No pump is involved. When the fill target is reached, the filling hose is pinched by a special pinching mechanism. However, the main issue with time/pressure is that there is no positive control of the flow. Fill volume is based on a calculation using time, pressure, and temperature; no actual flow is measured.

With net-weight systems, a scale sends a signal back to the dispensing unit, and as it approaches the target weight, it slows down the pump motor and stops the fill.

All such contemporary fluid dispensing systems employ dispense tips, which may be a “needle” or “nozzle”.

The needles/nozzles are connected to the pump or pressure source by feed tubes and are often positioned by a micropositioner, thereby providing precisely controlled volumes and positioning of fluid dispensing as needed. As an example, such fluid dispensing systems can be utilized for laboratory research and automation to precisely dispense a controlled amount of a liquid, such as a biologic reagent, onto an article such as a glass slide or sample tray. U.S. Pat. No. 6,739,478 to Bach et al. issued May 25, 2004 shows a precision fluid dispensing system with a two-piece positive displacement pump and a precision closed loop controller drive system that addresses the small volume precision dispensing requirements of bioscience applications. A micro-controller with closed loop feedback provides exact linear positioning and motion of the pump piston as well as optional control of a nozzle to provide exact micro-dispensing of fluids. Similarly, U.S. Patent Application 2005036692 by Bach further describes a two piston, two cylinder pump that can have multiple inlet and outlet

ports on either diameter. These multiple port dual diameter pumps can have ports for dispensing a common fluid through several outlet ports or can be used to bring different reagents into the pump though multiple inlet ports. The use of different inlet ports for sequential reagent input to the pump allows for pump mixing of reagents and the dispensing of a common mixed solution.

The conventional displacement (pumping) range for the above-described and other positive displacement pumps is approximately 500 ml to 5 ul, or smaller volumes if coupled to an active nozzle as described in patent U.S. Pat. No. 6,739,478. When volume are less than a few microliters, dispensing through traditional tubes connected to an output port are difficult at best. With such small volumes, the gravitational forces become negligible while the surface tension becomes dominant. The '478 patent describes an integrated active nozzle (FIG. 6) which acts as a secondary actuator to squeeze the fluid out of the output tube. Software provided on the controller can interface with the active nozzle. Thus, a command to move the piston can be synchronized to activate the nozzle resulting in micro drops.

Even smaller precision fluid pumps can be accomplished by using small piston and cylinders coupled to a magnetostrictive, piezoelectric or solenoid actuator. Magnetostrictive fluid pumps rely on expanding rods that serve as actuators. The rods are made of magnetostrictive material that changes dimensions in the presence of a magnetic field. Thus, the rods move in and out of a pumping chamber like a solenoid, thereby changing the volume of the chamber. The rods may be moved within a range of several tens of microns. There are no moving parts at all, and so magnetostrictive pumps can run reliably over a long period of time. For example, U.S. patent application Ser. No. 11/273,583 by Bach et al. employs magnetostrictive actuator(s) to accomplish the functions of precision fluid dispensing, reagent mixing, and microarray dispensing. U.S. patent application Ser. No. 10/688,331 by Bach et al. shows a magnetostrictive actuator valve used for removing small volumes of fluid or fluid containing cells in a flowing stream or incremental flowing stream.

While the technology described above improves fluid dispensing, mixing, and dispensing of fluids, conventional technology does not allow for optical analysis of the fluids being pumped, mixed or sorted through the needles/nozzles. It would be greatly advantageous to add an optical analysis capability for accomplishing fluid analysis within the dispensing needle/nozzle itself so that dispensing of pharmaceutical fluids can be monitored at the very last dispensing stage before the fluid is placed in the final container (vial, ampule, sample tray, etc). The present invention accomplishes this with a needle and nozzle design that allows for precision dispensing and mixing of fluids by assist of an integral optical system and a precision closed loop controller drive system that addresses the small volume precision dispensing requirements of bioscience applications.

### SUMMARY OF THE INVENTION

Accordingly, it is an object of the present invention to provide a needle/nozzle design for precision dispensing that facilitates monitoring of mixed fluids, particulates, detection of air and fluid surfaces, by assist of an integral optical system that interfaces the needle/nozzle directly to a precision closed loop controller drive system (utilizing feedback) for optical analysis thereof, especially for small volume precision dispensing requirements of bioscience applications.

It is another object to provide an aspirating needle/nozzle design with direct optical analysis of the needle/nozzle interior which is nevertheless a closed fluid flow system, with few moving parts, and reduced potential for contamination

It is another object to provide a needle/nozzle design as described above that has particular utility in bioscience applications.

According to the present invention, the above-described and other objects are accomplished by providing an improved needle and nozzle design that allows for precision dispensing and monitoring of mixed fluids, particulates, detection of air and fluid surfaces by assist of an integral optical system coupled to a closed loop controller drive system for real-time monitoring of the small volume precision dispensing requirements of bioscience applications. The needles/nozzles have an optically-transmissive wall coupled to an optical system including an optical detector and light source, at least the detector being connected to a closed loop controller drive system (e.g., a “needle/nozzle integrated optical analysis system”). The light source emits light that is transmitted into the needle/nozzle and into an analysis section defined along a path length within the confines of the needle/nozzle tip. The light may be transmitted to (and optionally reflected back from) the other side of the needle/nozzle tip to the detector for sensing, and any optical change in the analysis region can be observed via the transmitted/reflected light and used as feedback to control the pump drive system. One or more optical fibers may be used for coupling the detector to the needle/nozzle, in which case the fiber(s) are terminated by a lens at the distal end and optically coupled into the needle/nozzle. A gradient index lens employs a gradually varying index of refraction within the lens material itself, allowing light rays to be redirected towards a point of focus. Thus, for example, a GRIN lens such as an EndoGRIN™ or Selfoc™ lens may be carried at the distal end of the fiber(s) and optically coupled directly into the needle/nozzle. The gradient index lens serves as the optical focusing element and allows optical interrogation within the needle/nozzle. The incorporation of optical detection within the confines of an aspirating needle/nozzle has great utility, especially as the internal analysis volume decreases. For example, the present invention allow the detection in the needle/nozzle of femto-liter volumes of residual fluid. The pump and detection system can be controlled and synchronized by a microprocessor. Optical detection can be based on fluorescence, scattered light or both. Other detection techniques such as absorbance are also included in this application.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 shows a preferred embodiment of a needle/nozzle 2 in which the tubular wall 4 of the needle/nozzle is formed entirely of glass (or has an embedded glass core) according to a first embodiment of the invention.

FIG. 2 is a schematic view of the needle/nozzle 2 of FIG. 1 incorporated in a dispensing system.

FIG. 3 shows another embodiment of a needle/nozzle 20 in which the tubular wall 4 of the needle/nozzle is formed of stainless steel with opposing windows 14 in advance of the optical source 7 and detector 9, the tubular wall 4 being further formed with a lateral step defining a transverse elongated optical path length 6.

FIG. 4 shows yet another embodiment of a needle/nozzle 30 in which the optical path 6 is directed axially along the tubular wall 4 of the needle/nozzle 30

FIG. 5 shows yet another embodiment of a needle/nozzle 40 similar to that of FIG. 4 except that the source 7 and detector 9 are remotely coupled to the optical path 6 along the tubular wall 4 of the needle/nozzle 40 via an optical fiber 18.

### DETAILED DESCRIPTION OF THE PREFERRED EMBODIMENTS

The present invention is a precision fluid dispensing system that allows for precision dispensing of fluids through a needle or nozzle having an integral optical system. The present invention accomplishes this with a needle and nozzle design that allows for precision dispensing and monitoring of mixed fluids, particulates, detection of air and fluid surfaces by assist of an integral optical system built into the aspirating needle/nozzle and coupled to a closed loop controller drive system for real-time monitoring of the small volume precision dispensing requirements of bioscience applications. The novel concept of the present invention is a needle/nozzle having an optically-transmissive body coupled to an optical system including an optical detector and light source, at least the detector being connected to a closed loop controller drive system (e.g., a “needle/nozzle integrated optical analysis system”). The optically transmissive body can be masked by a light shielding jacket outside of the source/detection areas. In general operation, the light source emits light that is transmitted into the body of the needle/nozzle and into an analysis section defined along a lateral path length within the confines of the needle/nozzle tip. The light may be transmitted to (and optionally reflected back from) the other side of the needle/nozzle tip to the detector for sensing (the detector may be mounted opposite the light source on the needle/nozzle tip or adjacent to it). Either way, any optical change in the analysis region can be observed via the reflected light and used as feedback to control the pump drive system. The concept lens itself to various embodiments including: 1) a glass needle/nozzle embodiment in which the tubular body of the needle/nozzle is formed entirely of glass or has an embedded glass core; 2) a fiber-optic or fiber bundle piston embodiment in which the tubular tip of the needle/nozzle comprises an optical fiber or has an optical fiber embedded lengthwise therein; and 3) a GRIN lens (described below) configuration in which a GRIN lens is mounted in the needle/nozzle piston and is optically coupled through the needle/nozzle (as per 1 & 2 above) to form an optical analysis path length between the walls of the tubular body of the needle/nozzle.

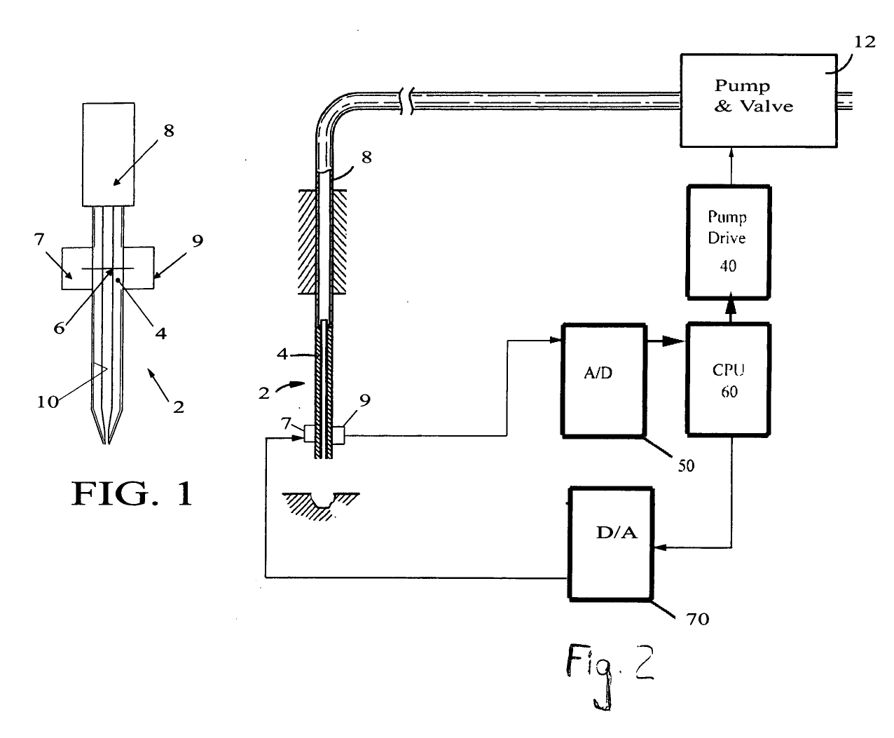

FIG. 1 shows a preferred embodiment of a needle/nozzle 2 in which the tubular wall 4 of the needle/nozzle is formed entirely of glass according to a first embodiment of the invention. The dispensing needle/nozzle 2 can vary in internal diameter from approximately 0.4 mm to 4.5 mm with various wall thickness. A typical glass needle would have an internal diameter of 1 millimeter with an outside diameter of 6 mm (for example a Valco International #CGCG41), The fluid exit end may be tapered to a thin wall section at the end of the needle to assist in dispensing. One skilled in the art will understand that the design of the needle may be square or other shape for transporting fluid. The optical polymers may also be from among the class of acrylates, polyimides, polycarbonates, and olefins (e.g., cyclobutene). The transmissive mid-wall section 4 is equipped with an optical system that includes an optical detector 9, and optical light source 7. The optical detector 9 and optical light source 7 are diametrically opposed across the mid-wall section 4 thereby forming an optical path length equal to the inner diameter of the mid-wall section 4. Preferably, the optical detector 9 and optical light source 7 are positioned as close as structurally possible to the end of dispensing needle/nozzle 2 to provide an optimal indication of fluid being dispensed. An optional but recommended light blocking coating/shield 10 is applied around the tubular wall 4 of the needle/nozzle except in the immediate area of the optical detector 9 and optical light source 7 in order to block out stray and ambient light. The coating 10 may be any optical light-blocker used in lens optics such as a thin aluminum polyimide film.

FIG. 2 is a schematic view of the needle/nozzle 2 of FIG. 1 incorporated in a dispensing system. Dispensing needle/nozzle 2 is coupled via flexible feed tube 8 to a remote pump and valve 12. As is known to those skilled in the art, multiple needle/nozzles 2 may be supplied by a single pump 12. Both the pump and valve 12 and are electrically connected to a drive controller 40 which controls the volumetric displacement of the pump 12. The drive controller 40 is in turn under the control of a processor CPU 60. The CPU 60 may be any of a variety of commercially available programmable logic controllers or a fully-equipped computer. Likewise, the drive controller 40 may be any of a variety of digital-to-analog pump drive control modules for controlling the displacement of the pump 12 piston. U.S. Pat. No. 6,739,478 describes a stepper motor drive system where the pump 12 piston is digitally adjusted to provide a precise distance between the end of the piston and bottom of the cylinder. Other drive systems are commercially available, including those used in syringe pumps by manufacturers such as Cavro and Hamilton, servo systems such as used in the Bausch & Strobel filling equipment for two piece pumps, or Bosch Packaging where steppers or servos are used with three piece piston cylinder pumps. Manual systems can also be used, such as those in the Ranin hand held pipetting devices.

The optical detector 9, and optical light source 7 of the integral optical system in needle/nozzle 2 are electrically connected through an analog to digital (A/D) 50, and a digital to analog (D/A) 70, respectively, to the CPU 60. In operation, the light source 7 emits light under control of the CPU 60, which drives the light source 7 via D/A 70. The light propagates through the mid-wall section 4 of needle/nozzle 2 along the optical path length 6, where it continues across the mid-wall section 4 into the detector 9 for sensing. The analog-to-digital (A/D) converter 50 converts the raw signal from detector 9 into a digital equivalent, which is in turn transmitted to the controller CPU 60 for interpretation and processing. The signal is analyzed to generate feedback as necessary to stop, control or modify the pump drive control signals emitted from the CPU 50 to the pump drive controller 40 to thereby control the pump 12. Thus, any optical change in the analysis region along path length 6 can be observed and used as feedback in controlling the pump 12. Specifically, the raw signal from detector 9 comprises an optical signature that can be digitized at A/D 50 and interpreted by CPU 60 to facilitate monitoring of mixed fluids or particulates, and detection of air and fluid surfaces. The optical signature may be a reflectance optical signature or a refractance optical signature. This optical signature, for example, indicates the position of an air-to-fluid interface within the needle/nozzle 2, or that the needle/nozzle 2 has come in contact with a liquid surface. Alternatively, the optical signature may indicate that all the fluid in needle/nozzle 2 has been dispensed out of the needle or nozzle. Where the needle/nozzle 2 is being used to suck back fluid (in which case there may be fluid at the tip on one side to be aspirated back inside the needle/nozzle 2), an optical signature optical signature that there is no fluid in needle/nozzle 2 may mean an error in the fluid transfer.

Where it is necessary to lengthen the optical path length to procure the desired optical signature, the path length may be doubled by locating the source 7 and detector 9 on one side of the wall 4 of dispensing needle/nozzle 2 (indeed, the source 7 and detector 9 may comprises a single component such as an LED array), and placing a reflector or beam splitter on the other side. In many cases the path length will be very small and this reflective-type path length allows for a longer pathlength. The short pathlength is best suited for fluorescence or light scatter detection.

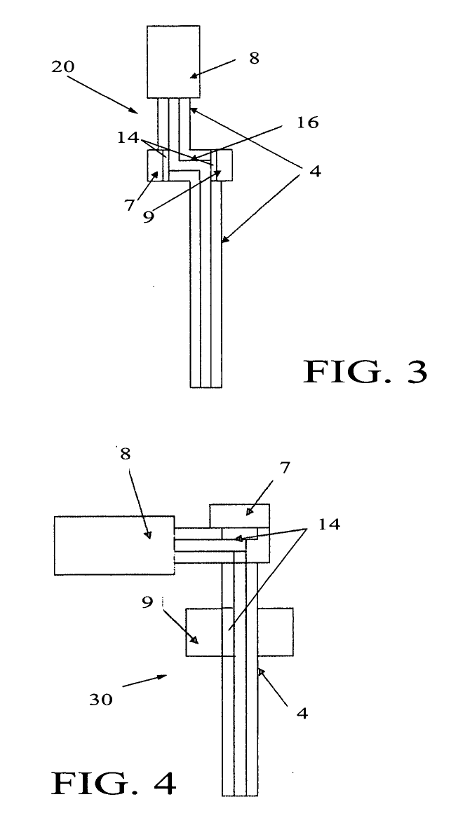

As an alternative to an optical glass needle/nozzle 2, two optical windows may be formed in an otherwise stainless steel needle/nozzle 2. This provides more flexibility in machining, and also provides more opportunity for increasing the optical path length 6. For example, FIG. 3 shows another embodiment of a needle/nozzle 20 in which the tubular wall 4 of the needle/nozzle is formed of stainless steel with opposing windows 14 in advance of the optical source 7 and detector 9, the tubular wall 4 being further formed with a lateral step defining a transverse elongated optical path length 6.

FIG. 4 shows yet another embodiment of a needle/nozzle 30 in which the optical path 6 is directed axially along the tubular wall 4 of the needle/nozzle 30. In this case the wall 4 of needle/nozzle 30 may be formed of stainless steel with a lateral coupling to tube 8, an elbow leading downward through a vertical section of tubular wall 4, and a downwardly directed window 14 at the elbow in advance of the optical source 7. This defines an elongate vertical optical path length 6 leading axially through the major length of needle/nozzle 30. A second window 14 may be located downward along the length of tubular wall 4 to provide a sensing aperture for detector 9. Tube 4 can also be made of a material allowing the detector 9 to see the fluid contained in wall 4. In this case the detector 9 may be an optical integrating sphere for collecting all the light scattered into the sphere. An integrating sphere is a conventional optical device for various purposes such as measuring the optical flux from a laser diode, light-emitting diode (LED) or bulb, or measuring scattering losses from a surface. It is a hollow sphere with a diffusely reflecting internal surface, typically two or more small openings (ports) for introducing light or attaching a photodetector, and often some so-called baffles, which are light barriers used to prevent direct illumination of a detector by a light source. The arrangement causes many diffuse reflections of the introduced light before it reaches detector 9, so that the light flux becomes very uniform at the detector 9, and nearly independent of the spatial and polarization properties of the introduced light from source 7.

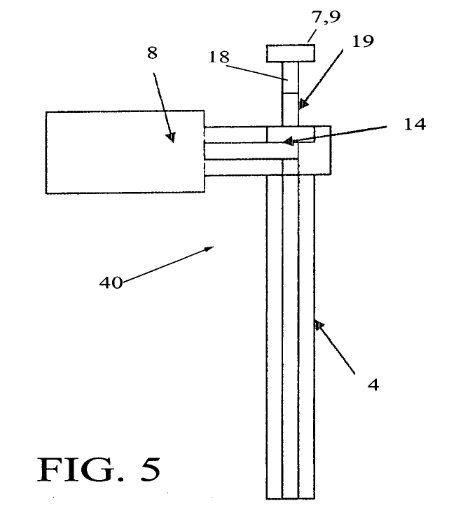

FIG. 5 shows yet another embodiment of a needle/nozzle 40 similar to that of FIG. 4 except that the source 7 and detector 9 are remotely coupled to the optical path 6 along the tubular wall 4 of the needle/nozzle 40 via an optical fiber 18. In addition, the optical fiber 18 is tipped by a lens 19 which accomplishes the source 7 and detector 9 integration to the dispensing needle/nozzle fluid path 4. The lens 19 is optically coupled to the vertical path length 6 through a window 14 into the tubular wall 4. In this case reflectance from the light that enters the upper fluid region of the tube walls 4 will be reflected back to the lens 19, gathered and used for the optical analysis.

In any case where fluid is aspirated into the needle 2 tip from a remote fluid source and dispensed in another location (e.g., “pick and place” dispensing), a reflectance optical signature will correlate the air to fluid interface inside the needle or nozzle. Thus, the optical signature can be used to detect fluid in the needle, the absence of fluid in the needle, air bubbles, particulates, and when the needle 2 has come in contact with a liquid surface. Consequently the detector 9 provides an indication as to the effectiveness of the fluid transfer as it detects the aspiration of fluid and the complete dispensing of the contained fluid in the needle.

The lens 19 may be a flat, convex or concave refractive lens 19, or a GRIN lens or graded fiber section may be used. GRIN is short for graded-index or gradient index, which is an optical element having a varying refractive index. More specifically, a GRIN lens is a lens whose material refractive index varies continuously as a function of the spatial coordinates in the material. Similarly, a graded-index fiber is an optical fiber having a core refractive index that decreases radially outward toward the cladding. There are two basic types of GRIN lenses: radial or axial (or RGRIN and AGRIN, respectively). The preferred embodiment employs an RGRIN lens having a flat frontal surface capable of focusing light just as a normal lens with curved surfaces does. Thus, the RGRIN lens is effectively used as a high quality image relay. There are a variety of suitable commercially-available GRIN lenses that will suffice, including EndoGRIN lenses™ from Gradient Lens Corporation or Selfoc™ lens from NSG, Inc. In either case, the lens 19 is optically coupled directly to the window 14 (or through optically transmissive walls 4.

In the embodiments of FIGS. 4-5 if fluid is present an optical reflective signal can be detected by detector 9. If the fluid is not present little to no optical reflective signal is detected.

Again, one skilled in the art should understand that other needle/nozzle configurations may be suitable and the use of glass rods, fibers, GRIN lenses, etc. are considered to be within the scope of the invention.

It should now be apparent that the above-described embodiments incorporate an improved needle and nozzle design that allows for precision dispensing and monitoring of mixed fluids, particulates, detection of air and fluid surfaces by assist of an integral optical system coupled to a closed loop controller drive system for real-time monitoring of precision dispensing requirements of bioscience applications. The needles/nozzles have an optically-transmissive wall coupled to an optical system including an optical detector and light source, at least the detector being connected to a closed loop controller drive system (e.g., a “needle/nozzle integrated optical analysis system”). The light source emits light that is transmitted into the body of the needle/nozzle and into an analysis section defined along a path length within the confines of the needle/nozzle. The light may be transmitted to (and optionally reflected back from) the other side of the needle/nozzle body to the detector for sensing, and any optical change in the analysis region can be observed via the transmitted/reflected light and used as feedback to control the pump drive system.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A fluid dispensing system comprising:
a pump;
a tube in fluid communication with said pressure source;
a needle/nozzle attached distally to said tube and having walls defining a fluid chamber to a dispensing tip;
an optical viewing system optically coupled to the chamber of said needle/nozzle;
a processor connected to said optical viewing system; and
a pump drive controller connected between said processor and said pump for controlling displacement of said pump actuator in accordance with feedback from said optical viewing system.

2. The fluid dispensing system according to claim 1, wherein said needle/nozzle walls comprise light-transmissive optical glass.

3. The fluid dispensing system according to claim 1, wherein said aspirating needle/nozzle walls comprise light-transmissive polymeric material.

4. The fluid dispensing system according to claim 1, wherein said optical viewing system is optically coupled to the chamber of said aspirating needle/nozzle by at least one optical fiber.

5. The fluid dispensing system according to claim 1, wherein said optical viewing system comprises a light source and detector optically coupled to the chamber of said aspirating needle/nozzle.

6. The fluid dispensing system according to claim 5, wherein said detector is optically coupled to the chamber of said aspirating needle/nozzle by a lens.

7. The fluid dispensing system according to claim 6, wherein said lens comprises a graded index lens.

8. The fluid dispensing system according to claim 1, wherein the walls of said fluid chamber are substantially coated with a light blocking coating.

9. The fluid dispensing system according to claim 1, wherein said optical viewing system
facilitates monitoring of mixed fluids, particulates, detection of air and fluid surfaces

10. The fluid dispensing system according to claim 9, wherein said optical viewing system creates a reflectance optical signature indicating the position of an air to fluid interface within the needle/nozzle.

11. The fluid dispensing system according to claim 9, wherein said optical viewing system
creates an optical signature indicating that the needle/nozzle has come in contact with a liquid surface.

12. The fluid dispensing system according to claim 9, wherein said optical viewing system
creates an optical signature indicating that all fluid has been dispensed out of the needle/nozzle.

13. The fluid dispensing system according to claim 9, wherein said optical viewing system
creates an optical signature indicating that there remains no fluid in the needle/nozzle after an aspiration in air.
